(19) United States
(12) Patent Application Publication
(10) Pub. No.: US 2010/0095829 A1
(43) Pub. Date: Apr. 22, 2010

(54) REHEARSAL MIX DELIVERY

(75) Inventor: Phillip Dean Edwards, Austin, TX (US)

Correspondence Address: RAMAN N. DEWAN;JACKSON WALKER, L.L.P., 100 CONGRESS AVENUE, SUITE 1100, AUSTIN, TX, 78701, US

(73) Assignee: REHEARSAL MIX, LLC, Austin, TX (US)

(21) Appl. No.: 12/580,939

(22) Filed: Oct. 16, 2009

Related U.S. Application Data
(60) Provisional application No. 61/106,106, filed on Oct. 16, 2008.

(51) Int. Cl. G10H 1/08

(52) U.S. Cl. 84/625

(57) ABSTRACT

Rehearsal mixes are provided for transport by disclosed methods, services, and computer programs. Transported rehearsal mixes include one or more music tracks that are at an adjusted (e.g., higher or lower) sound level compared to sound levels of other music tracks to emphasize or de-emphasize a part that a musician is required to learn, for example. Disclosed embodiments may include, communicate with, or be integrated with automated planning systems for automatically providing rehearsal mixes to musicians in response to the musicians indicating their planned participation in a performance or rehearsal. Backing tracks may be automatically provided to a music director if there is an unfilled need for a live musician at a planned performance.

### BACKGROUND

1. Field of the Disclosure

The present disclosure relates to multimedia services, and more particularly, to providing rehearsal mixes.

2. Description of the Related Art

Performers may be required to learn instrumental or vocal parts for an upcoming performance of a song. To learn the part, the performer may be required to listen to a recording of the song in which all parts, including the part that must be learned, are at a standard sound level (i.e., recorded level).

### BRIEF DESCRIPTION OF THE DRAWINGS

FIG. 1 depicts an exemplary environment for providing rehearsal mixes in accordance with disclosed embodiments;

FIG. 2 depicts a disclosed service for providing rehearsal mixes;

FIG. 3 depicts a disclosed method for providing rehearsal mixes; and

FIG. 4 illustrates, in block diagram form, a data processing system within which a set of instructions may operate to perform one or more of the methodologies, systems, or services discussed herein.

### DESCRIPTION OF THE EMBODIMENT(S)

In one aspect, a disclosed service includes providing a rehearsal mix that has a plurality of tracks. The tracks, when mixed at a standard sound level, provide a standard music mix. However, in the rehearsal mix, one or more of the tracks are provided at an elevated sound level for emphasis. In some embodiments, tracks may be provided at lower or muted level for rehearsing. A first portion of tracks for a song are provided at a standard level and a second portion of the tracks are provided at an altered (e.g., elevated) level, relative to the standard level. Responsive to a user input, the rehearsal mix is transported to a user through streaming or download. The rehearsal mix may be downloaded to a storage (e.g., a hard drive on a user client) local to the user or the rehearsal mix may be streamed substantially in real-time with a rehearsal. Transporting may occur through user datagram protocol (UDP) packets or transmission control protocol (TCP) packets, as examples. In addition to the rehearsal mix, backing tracks may be provided for transport. The backing tracks include tracks or stems for the parts that are not provided with the transport rehearsal mix at an altered (e.g., elevated) level (i.e., that are provided at a standard level).

In some embodiments, a transported rehearsal mix includes digital rights management data that may limit the number of times the rehearsal mix can be played, may limit the number of times the rehearsal mix can be copied, or may limit the rehearsal mix from being played using unauthorized hardware. The transported rehearsal mixes may include click tracks and may be selectable according to musical key.

In another aspect, a disclosed method generates part specific rehearsal mixes and includes receiving user input for a part specific mix and providing the part specific mix for transport to a user. In particular embodiments, the user input includes a composition identifier that indicates a musical composition and a track identifier that indicates a track from the composition that is to be included in the part specific mix at an altered sound level (i.e., at a level that is higher or lower than sound levels at which other tracks are provided). The part specific mix may be downloaded or provided to the user or a designee of the user. A normal mix may also be included for transport to the user that includes a version of the musical composition with the previously elevated portion at a standard sound level. The part specific rehearsal mixes may be streamed in real-time during a rehearsal or downloaded to a storage (e.g., a hard drive a user client) for later use.

In still another aspect, a computer program stored on one or more tangible computer readable media includes instructions for providing rehearsal mixes for transport. Specifically, instructions access a plurality of music tracks of a composition, receive user input requesting a rehearsal mix, and provide the requested rehearsal mix for transport. The music tracks include a portion of music tracks at a standard sound level and a portion of music tracks at an adjusted (e.g., elevated) sound level (relative to the standard sound level.) Further instructions provide backing tracks for transport that correspond to music tracks included with the rehearsal mix at the standard sound level. The rehearsal mix may be streamed substantially in real-time with a rehearsal or provided for download to a storage (e.g., a computer hard disk) for later use.

Accordingly, disclosed embodiments can provide performers with rehearsal mixes that have one or more tracks at an elevated sound level for emphasis. Alternatively, a rehearsal mix may include one or more tracks at a muted or lower sound level, so a musician can play the part that is being learned while simultaneously hearing other portions (e.g., a piano or vocal track) of a song. If a guitar player needs to learn his or her part in preparation for an upcoming performance, the guitar player may request, from an embodied service, a rehearsal mix with a guitar track at an elevated sound level compared to other tracks that may include bass, drums, and vocals. In addition, if a bass player needs to learn his or her part in preparation for the same performance, the bass player may similarly request from the embodied service a further rehearsal mix with the bass track at an elevated sound level compared to other tracks including guitar, drums and vocals. Accordingly, each performer preparing for the upcoming performance may download a rehearsal mix corresponding to the performer's part. Additional mixes may be provided by disclosed methods, services, or machines with one or more tracks at lower or muted levels, to enable the musicians to further rehearse a performance.

Some embodied systems may operate with or communicate with planning software used by music directors to organize and plan for an upcoming performance of a musical composition (e.g., a song). For example, a music director may use a planning software program that allows for the selection of a song that will be played at the upcoming performance. If the planning software knows that a bass player, drummer, keyboard player and guitar player are needed for the upcoming performance, the planning software may automatically contact musicians that may be available for the performance. If a bass player indicates that he is available for the upcoming performance, disclosed systems may automatically send the bass player a rehearsal mix with the bass portion of the composition at an adjusted (e.g., elevated or lowered) level compared to, for example, the drum track, the keyboard track, and the guitar track, which are provided within the rehearsal mix at standard or reduced levels.

In the above example, if the guitar player and the drummer indicate that they are available for the upcoming performance, disclosed systems may automatically send rehearsal mixes for use by the musicians to assist them in learning their parts. In some embodiments, in addition to the rehearsal mixes that are sent to the users, a standard composition with all tracks at standard levels may be included so that the musicians may hear the composition as it was intended to be played. If no keyboard player, for example, responds as available for the upcoming performance, disclosed embodiments may automatically send to a music director a backing track that includes a prerecorded keyboard stem for the composition that can be included with the live performance attended and performed by the other musicians (e.g., the guitar player and the bass player). In this way, disclosed embodiments provide music directors with automated systems for planning performances and rehearsals by communicating with musicians to determine their availability, automatically providing the musicians with rehearsal mixes for their parts, and automatically providing backing tracks for parts of the musical composition that are not to be performed live during the performance.

Disclosed systems may receive input from a user (e.g., a musician or music director) that indicates a requested relative sound level of one or more tracks compared to the sound levels of other tracks. For example, a vocalist may request a rehearsal mix with a soprano portion five times louder than other vocal or instrument tracks. Rehearsal mixes may also be requested with certain tracks (e.g., a soprano portion) at lower sound levels compared to other tracks. In some embodiments, rehearsal mixes include digital rights management (DRM) data that controls the manner in which the rehearsal mix is used. For example, DRM data may require that the rehearsal mix be played only a limited number of times, only for a limited number of days, or only on predetermined hardware.

As disclosed herein, the term “song” may refer to a musical composition that is comprised of one or more audio stems and one or more vocal tracks. Vocal tracks typically are derived from or simulate human voices. Stems are individual audio components that, in accordance with disclosed embodiments, may be included in a rehearsal mix. In addition, stems may be included as backing tracks for instruments that are not included in a rehearsal. The terms “audio track,” “music track,” or “track,” as used herein may be interchangeable with “audio stem” or “stem.” As used in this disclosure, a “normal level” or “standard level” is a level at which a track is typically provided in the composition for consumption by the general public. A normal level or standard level would typically be the level at which a mixing engineer and/or producer sets for a track during an original production of the composition. As used herein, the terms “rehearsal mix” and “up mix” may be interchangeable. Similarly, disclosed embodiments may include a “minus mix” or “down mix,” which refers to a rehearsal mix having a track or tracks with a level or levels lower than a normal or standard level.

Audio stems typically are derived from or simulate musical instruments. Some audio stems are created by synthesizers or other electronic equipment. Disclosed embodiments may process vocal tracks, audio stems, lyric tracks, and video segments for inclusion with downloaded rehearsal mixes or compositions. Some disclosed embodiments provide a plurality of selectable audio stems, video segments, lyric tracks, click tracks, and in some embodiments, vocal tracks for selection by a music director or musician. The individual tracks may be included with live performances. In some embodiments, individual audio stems may be manipulated electronically after transport to achieve results desired by a music director. For example, down mixes, up mixes, and minus mixes may be created.

Disclosed embodiments may include a mixer for combining external sound such as from microphones or musical instruments with transported audio tracks. In some embodiments, audio tracks are received locally and presented substantially in real time in a performance or rehearsal. In some embodiments, transported audio tracks include timing information that provides visual or audible indicators to aid performers and music directors.

Using a graphical interface, a user (e.g., a performer, musician, or music director) may select one or more downloadable audio stems for inclusion with a rehearsal mix. In some embodiments, if the rehearsal mix contains a video component, the user may select or enter lyrics for inclusion with the rehearsal mix. After selection, indications of the selected audio stems may be presented on a graphical interface. The graphical interface may display timing information and may also display wave forms for each of the downloaded audio stems. In some embodiments, during a rehearsal or performance, the user views each audio stem as a wave form superimposed on a timeline. Embodied systems may receive vocal signals, instrumental signals, and/or video signals from one or more live sources (e.g., a guitarist) or one or more external sources and include them with the performance or rehearsal. In some embodiments, a music director may record and loop the signals received from such sources and loop them within the rehearsal or performance. The vocal signals, instrument signals, and video signals may include a reference signal with timing information used for synchronization. In some embodiments, participants in a rehearsal are in separate locations. Additionally, disclosed embodiments may allow participants to upload their rehearsed parts to a server, a music director client, or the clients of other participants.

Some disclosed embodiments, in addition to providing rehearsal mixes with some parts at adjusted (e.g., elevated) sound levels, provide music stems that are used as backing tracks during a live performance or rehearsal. These backing tracks (i.e., music stems) may be from any of several musical instruments and may be in any of several musical keys (e.g., in the key of C). Examples of musical instruments include, but are not limited to: bass guitar, piano, electric guitar, acoustic guitar, organ, bongos, chimes, drums, gong, trumpet, trombone, tambourine, banjo, harmonica, symbols, synthesizer, piccolo, violin, oboe and harp. The music stems may be in any of several audio formats including but not limited to WAV (Windows® Wave), WMA (Windows® Media Audio 8), WMV (Windows® Media Video), and MP3 (MPEG-½ Audio Layer III). The music stems may have associated time codes used for synchronization. The time codes may be embedded in metadata and may include SMPTE time codes with a binary coded identifier that includes information in the following format: hour;minute;second;frame. In addition to music stems and possibly video segments that are provided for transport, one or more click tracks may be available for transport. Typical click tracks provide a series of audio cues used to synchronize sound recordings and may be used by one or more musicians or music directors during rehearsals and/or performances.

When a musical composition is recorded, a corresponding master recording may be made. The master recording may be referred to as an “original master recording.” Masters may be recorded in digital or analog format. Copies of the recording for distribution may be made from the master recording. Recordings that are stored to computer hard disks and similar data storage devices may be referred to as “session files.” For some recordings, each microphone signal or line input (e.g., from an instrument) is recorded to its own track or stem on a multi-track recorder. Subsequently, the signals that are recorded on the multi-track format may be individually reproduced, compressed, enhanced (e.g., through noise reduction), equalized, and mixed to a mono or multi-channel (e.g., stereo) recording. A multi-track recording may be remixed in different ways according to preferences of producers and how it will be used. The tracks or stems may be at one or more “standard” or “normal” sound levels, as optimized by a producer, mixing engineer, or automated system. In some embodiments, multiple stems of the same track are stored in distinct musical keys. Musical composition masters (e.g., song masters) are often owned by the author of the musical composition or the author's assignee. The owner of the master may license copies of the master for playing by individuals, for example, using files on compact discs or other media. A sale of the master typically refers to a purchase of intellectual property and, in many cases, the right to license others to make and play copies of the master. Disclosed services and methods may provide user input regarding license terms in response to user input requesting the download of one or more stems or rehearsal mixes (e.g., up mixes or down mixes) containing the stems.

A single musical composition may be recorded in several tracks or stems. For example, one stem may be for lead vocals, one stem may be for backup vocals, one stem may be for guitar, and so on. A drum kit may have multiple microphones, and a mixing engineer may enhance multiple stems and save the enhanced stems as a downloadable drum kit stem. A mastering engineer or producer may process individual tracks and create a master recording, which results in a song or musical composition. In accordance with disclosed embodiments, mastered stems (e.g., from individual instruments) may be provided as backing tracks to users for download. The sound levels of individual stems may be adjusted (e.g. raised or lowered) in response to user input requesting a rehearsal mix (e.g., up mix or down mix). In some embodiments, a service enables a user to select and download or stream stems for a song or musical composition to hardware local to the user. Digital rights management may be added to downloaded stems to control or limit the manner in which the stems are used subsequent to downloading. For example, the number of times the digital stem may be used, played, or copied may be limited to a predetermined number. In some embodiments, digital rights management features may prompt a user to renew a license for one or more downloaded stems.

In addition to providing individual music stems for download, disclosed embodiments may provide pre-recorded rehearsal videos for download. Videos offered for download may be rendered and recorded to include song lyrics. Additionally, videos offered for download through disclosed embodiments may be synchronized, sized, and timed to match the length and makeup of the corresponding audio portions of the songs. Embodied services and methods, in response to user input or otherwise, may also include sizing a video segment to match the length of a song and providing the sized video segment for download. In addition, in response to user input, lyrics may be added into video segments automatically by disclosed methods and services and rendered for download by the user.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

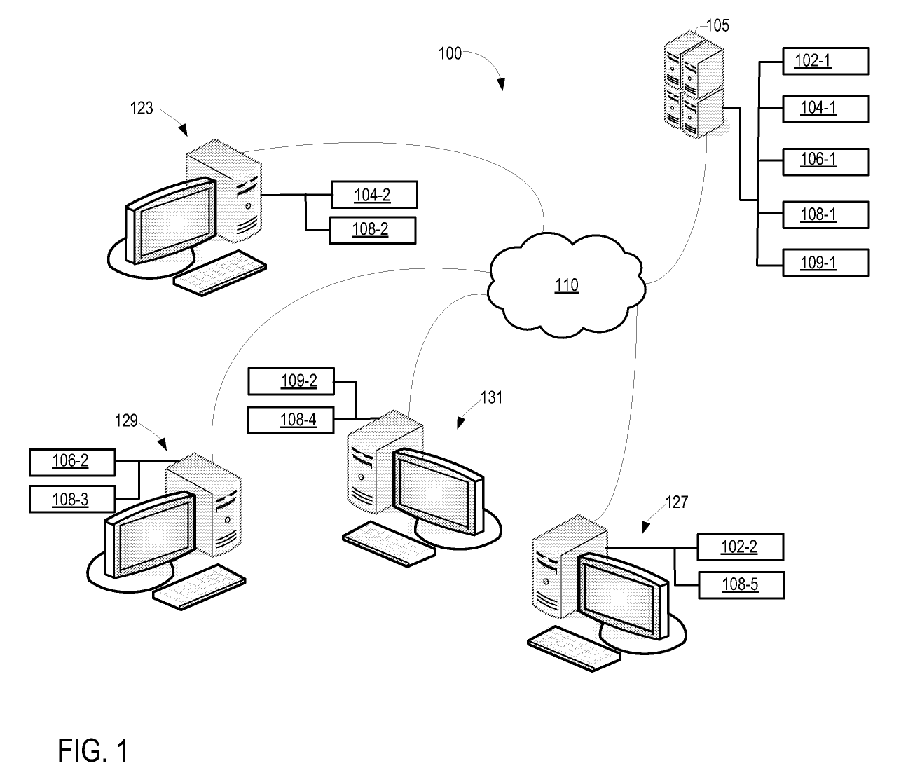

As shown in FIG. 1, server 105 is communicatively coupled to network 110 to provide rehearsal mixes to client 123, client 129, client 127 and client 131. Network 110 may be an Internet, an intranet, a wide area network (WAN), or a local area network (LAN), as examples. In an exemplary scenario, client 123 is associated with (e.g., belongs to or is accessed by) a bass player and receives upmix 104-2, which is a copy of upmix 104-1 and may be stored local to server 105 and provided as a service through network 110. Upmix 104-2 and upmix 104-1 have a bass track that is provided at an elevated sound level compared to the sound levels of other instrument tracks (e.g., a guitar track). In some embodiments, upmix 104-2 is downloaded to client 123. Alternatively, upmix 104-2 may be streamed substantially in real time with a rehearsal or performance. Client 123 may be a personal computer, portable music device, telephone, or other hardware device capable of receiving streaming or downloaded copies of upmix 104-1.

Similar to client 123, client 129 receives upmix 106-2, which is a copy of upmix 106-1 that may be stored local to server 105 or may be accessed by server 104 in response to user input to transport a copy of upmix 106-1. Continuing the above exemplary scenario in which client 123 is associated with a bass player, client 129 is associated with a guitar player and upmix 106-2 has a guitar track that is provided at an adjusted (e.g., elevated) level compared to the sound levels of other instrument tracks (e.g., the bass track). Upmix 104-2 also includes the guitar track (provided with upmix 106-2 at an adjusted level), at a normal level or reduced level to allow the bass player to hear the guitar track but to add emphasis to the bass track for the bass player. Likewise, upmix 106-2 contains, at a normal or reduced level, the bass track that is provided at an adjusted (e.g., elevated) level (relative to other tracks) in upmix 104-2 to the bass player. In this way, musicians are provided with rehearsal mixes that have their respective parts at a relatively elevated and/or lowered level compared to other music tracks.

Continuing the above exemplary scenario, client 127 is associated with a keyboard player and upmix 102-2 is a copy of upmix 102-1 which is an upmix for a keyboard player. Upmixes 102 have a keyboard track that is at an elevated level compared to other music tracks (e.g., the bass track and the guitar track) provided within upmixes 102. As shown, client 127, in addition to receiving upmix 102-2, receives composition 108-5, which is a copy of composition 108-1. Compositions 108 may be copies of an original master recording and include all music tracks at standard levels, or the levels at which they were set by a mixing engineer or producer when creating an original mix of the composition. Having a copy of composition 108-1 allows musicians and music directors to hear the composition as it was intended to be played, with all parts at standard levels, which may assist with rehearsals.

As shown in FIG. 1, client 131 may be associated with a music director that receives composition 108-4 and backing track 109-2. Backing track 109-2 is a copy of stem 109-1. In the above exemplary scenario, if the music director is managing preparation for a musical performance and a drummer is unavailable for the performance, the music director may request and receive backing track 109-2 that can be integrated into the performance to provide percussion elements for example that are intended to be included with composition 108-4. In some embodiments, the musical director receives more than one backing track, and additionally may receive each of the rehearsal mixes provided to the other performers (e.g., upmixes 104-2 and 106-2). Transport of upmixes (e.g., 104-2) and backing tracks (e.g., backing track 109-2) may include downloading (e.g., through file transfer protocol) or may include streaming that occurs substantially simultaneously with a rehearsal or performance. Accordingly, transport of the rehearsal mixes may include sending user datagram protocol packets (UDP) packets and/or transmission control protocol (TCP) packets. In some embodiments, a rehearsal occurs at multiple locations and clients for each musician (e.g., client 127) transmit substantially in real time a live rehearsal track (e.g., a keyboard rehearsal track) to other clients (e.g., clients 123, 131, and 129). Alternatively, the rehearsal track (e.g., a keyboard rehearsal track) may be uploaded from a client (e.g., client 127) and stored locally to server 104 for later download by other clients (e.g., client 131). In this way, a music director, for example, may track the progress of rehearsing musicians and determine whether a future musical performance is likely to be a success.

Some disclosed systems provide DRM with transported upmixes. DRM may include any current or future access control technology to limit usage of the transported upmixes or backing tracks. For example, upmix 104-2 may include DRM data that prevents upmix 104-2 from being copied to any data processing system (e.g., a personal computer) other than client 123. Alternatively, the DRM data may set upmix 104-2 to expire after a predetermined time. In some cases, DRM data included with upmix 104-2 may report back to server 104 regarding any usage and/or copying of upmix 104-2. Such systems include and use DRM data to control or monitor copying and use of rehearsal mixes such as up mix 104-2.

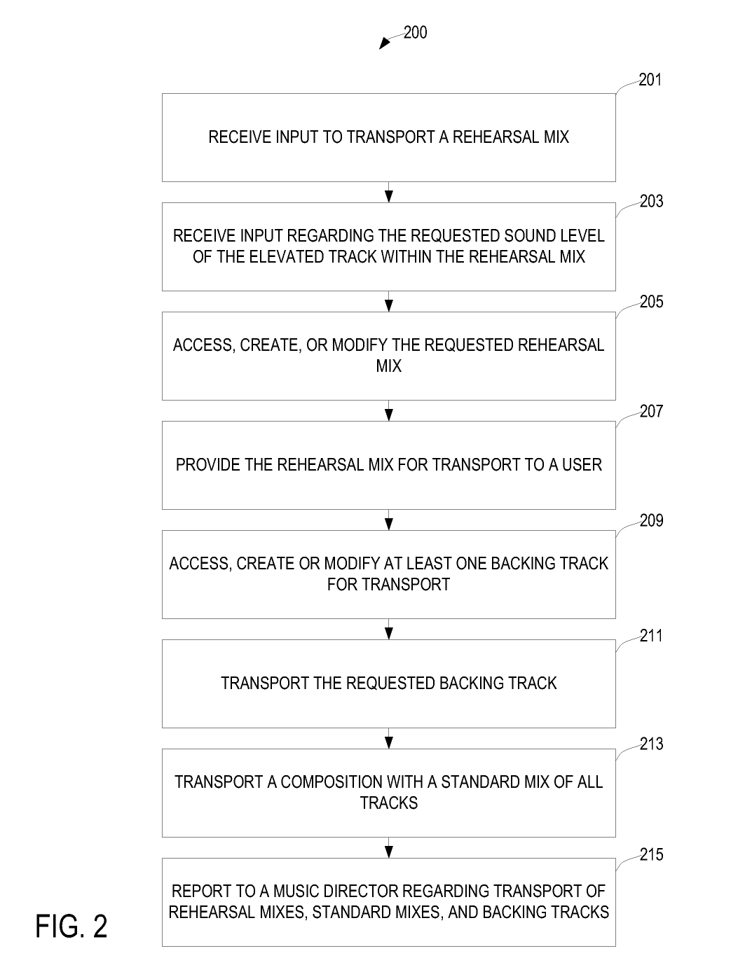

FIG. 2 depicts a service 200 with representative elements for providing rehearsal mixes in accordance with disclosed embodiments. As shown, input may be received (block 201) requesting transport of a rehearsal mix to a user (i.e. to a user client or device). In some embodiments, the user input is automatically generated from planning software upon the user accepting a job as a musician to perform at a future performance or rehearsal. The input may include an identifier of the composition and an identifier regarding which musical track to provide at a relatively adjusted (e.g., elevated) level within the rehearsal mix. Service 200 may also include receiving input (block 203) regarding the relative sound level at which the adjusted musical track within the rehearsal mix is provided. For example, the input may specify that a guitar part is twice as loud as other instrumental parts in the transported rehearsal mix. The input may also specify, for example, whether to include vocal tracks or other instrumental tracks with the rehearsal mix. In some embodiments, transported rehearsal mixes may include a click track to assist the musician with timing during a rehearsal. To this end, received input may specify whether to include the click track with the transported rehearsal mix.

As shown, service 200 includes accessing, creating, or modifying (block 205) the requested rehearsal mix. The requested rehearsal mix may be stored on a server before the server receives the user input or the rehearsal mix may be created “to order” in response to user input. Alternatively, the transported rehearsal mix may be the result of modifying a stored version of a rehearsal mix. Some embodied services may store pre-made rehearsal mixes that are popular while creating less popular rehearsal mixes upon request. To this end, rehearsal mixes may be ranked to determine and compare popularity. In disclosed services, rehearsal mixes may be accessed from local sources (e.g., hard drives) or over a network from third party sources such as the copyright holder or the designated distributor of the composition. Upon accessing the rehearsal mix, it is provided for transport (block 207) to the user. In some embodiments, the rehearsal mix is provided for download or is streamed to a user client (e.g., streamed substantially in real time with a rehearsal).

In addition to providing rehearsal mixes, embodied services may provide backing tracks for transport to users (e.g., musicians or music directors). If a musical performance is planned and not all parts are to be provided by live musicians, the backing tracks may be used to complete the composition. Accordingly, backing tracks may be accessed, created, or modified (block 209) and provided for transport (block 211) with the rehearsal mixes. In addition to providing for transport the rehearsal mixes, and optionally one or more backing tracks, disclosed services may provide for transport (block 213) a composition with a standard mix of all tracks. The standard mix of all tracks typically includes all musical tracks at levels originally set during a master recording. The standard mix of all tracks provides musicians and music directors with an indication of one way that a musical composition was intended to be played. In some embodiments, service 200 optionally includes providing (block 215) a report to a music director or other administrator regarding the transport of rehearsal mixes, standard mixes, and backing tracks. Such reports may be integrated with musical performance planning software to provide the music director with an indication of which musical parts have been filled, which musical parts remain to be filled, and which backing tracks may be required to complete a future performance.

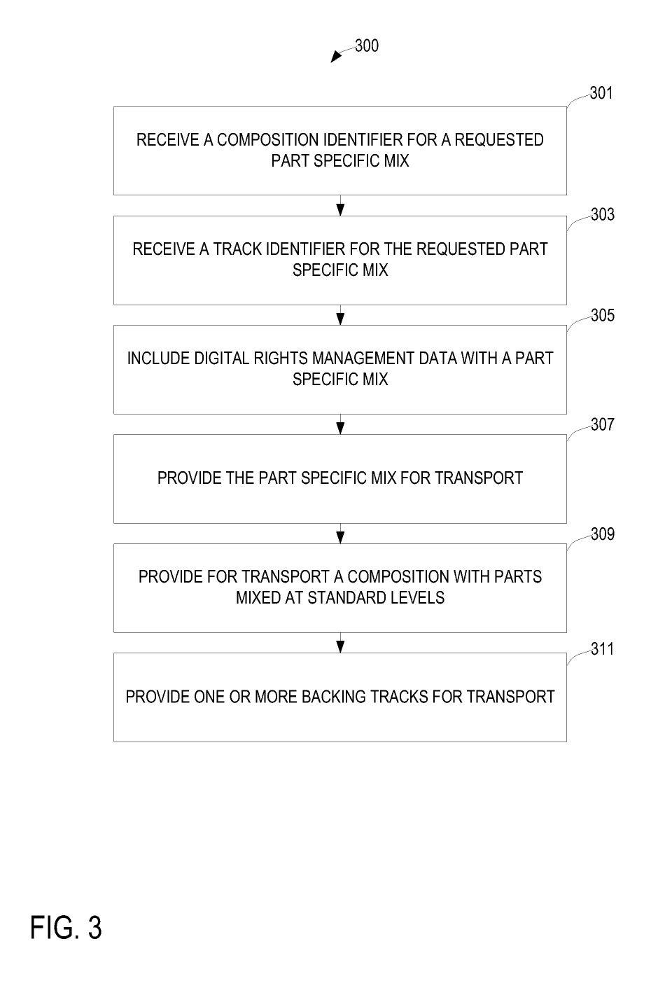

FIG. 3 depicts a methodology 300 with representative elements for providing part specific mixes in accordance with disclosed embodiments. As shown, methodology 300 includes receiving a composition identifier (block 301) for a requested part specific mix. The composition identifier typically is the name of the song to be performed at a future performance. Methodology 300 further includes receiving a track identifier (block 303) for the requested part specific mix. The track identifier specifies one or more tracks that should be included with a part specific mix at a sound level that is relatively higher or lower compared to sound levels of other tracks. For example, a guitar player may request a part specific mix with a rhythm guitar part at a higher sound level compared to the parts (of other instruments) in the part specific mix. As examples, the track identifier may be “bass guitar,” “lead vocals,” “guitar solo,” “keyboards,” “bongos,” “percussion,” “soprano,” or the like. In some cases, the track identifier may include multiple instrumental or vocal parts that are requested at higher or lower sound levels compared to other parts. The track identifier may also include a request to receive a click track included with the part specific mix. In some cases, a part specific mix may be selectable according to a musical key.

As shown in FIG. 3, DRM data may be included (block 305) with a part specific mix to limit, for example, the number of times a part specific mix is played or copied. The part specific mix is provided for transport (block 307), which may include streaming the part specific mix or downloading it to a user client or device. The composition with all parts mixed at standard levels (i.e., at levels substantially identical to or similar to those in a master recording) may be provided for transport (block 309), to provide a musician or music director an indication of one way a composition is intended to be played. Methodology 300 may also include providing one or more backing tracks (block 311) for transport. If a planned musical performance may be enhanced by a backing track, or a musician is not available for playing a specific part at the planned musical performance, a music director, administrator, planning software, or musician may request the backing track. Transport of the backing track may occur by download prior to the performance or may occur substantially simultaneously with the performance through streaming. In some cases, a music director may designate that a part specific mix is sent to the music director's designee, for example. The part specific mix may be sent to the musician's or the designee's respective hardware device or e-mail account, as examples.

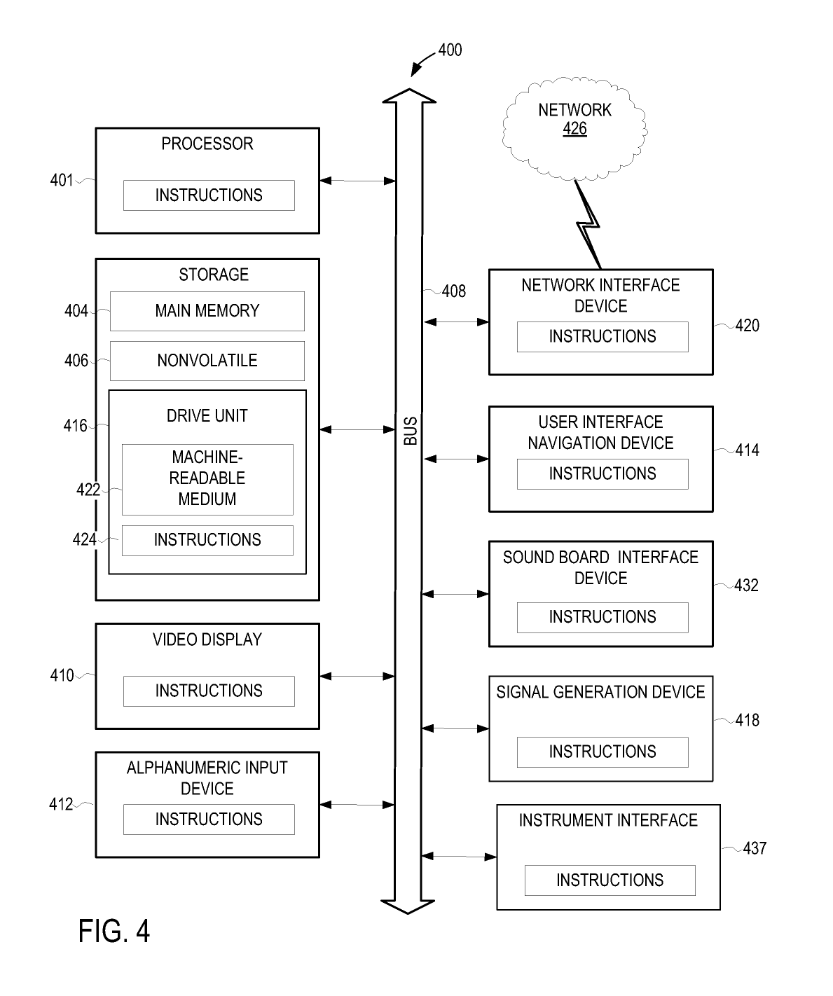

FIG. 4 illustrates in block diagram form a data processing system 400 within which a set of instructions may operate to perform one or more disclosed methods, systems, or services. Data processing system 400 may operate as a standalone device or may be connected (e.g., networked) to other data processing systems. In a networked deployment, data processing system 400 may operate in the capacity of a server or a client data processing system (i.e., computer) in a server-client network environment, or as a peer computer in a peer-to-peer (or distributed) network environment. Example data processing systems include, but are not limited to a DAW, a mixer, personal video recorder, a personal computer (PC), a web appliance, a network router, a switch, a bridge, a server, or any machine or component capable of executing a set of instructions (sequential or otherwise) that specify actions to be taken by that machine or component. Further, while only a single data processing system is illustrated, the term “data processing system” shall also be taken to include any collection of data processing systems that individually or jointly executes a set (or multiple sets) of instructions to perform any one or more of the disclosed methods or services.

As shown, data processing system 400 includes a processor 402 (e.g., a central processing unit, a graphics processing unit, or both), a main memory 404, and a nonvolatile memory 406 that may communicate with each other via a bus 408. In some embodiments, main memory 404 and/or nonvolatile memory 406 may be used to store the upmixes, video segments, music stems, and lyrics information. Data processing system 400 may further include a video display unit 410 (e.g., a television, a liquid crystal display or a cathode ray tube) on which to display waveforms of music stems, timing information, and the like. Data processing system 400 also includes an alphanumeric input device 412 (e.g., a keyboard), a user interface (UI) navigation device 414 (e.g., a mouse), a drive unit 416, a signal generation device 418 (e.g., a speaker) and a network interface device 420. The input device 412 and/or the UI navigation device 414 may include a processor (not shown), and a memory (not shown). The drive unit 416 includes a machine-readable medium 422 that may have stored thereon one or more sets of instructions and data structures (e.g., instructions 424) embodying or utilized by any one or more of the functions, services, or methods described herein. The instructions 424 may also reside, completely or at least partially, within the main memory 404, within nonvolatile memory 406, within video display 410, within alpha numeric input device 412, within network interface device 420, within signal generation device 418, within sound board interface device 432, within instrument interface device 437, and/or within the processor 402 during execution.

The instructions 424 may further be transmitted or received over a network 426 via the network interface device 420 utilizing any one of a number of transfer protocols (e.g., broadcast transmissions, HTTP). While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” should also be taken to include any medium that is capable of storing, encoding or carrying a set of instructions for execution by the machine (i.e., data processing system) and that cause the machine to perform any one or more of the disclosed services, functions, or methods, or that is capable of storing, encoding or carrying data structures utilized by or associated with such a set of instructions. The term “machine-readable medium” shall accordingly be taken to include, but not be limited to, solid-state memories, optical disks, and magnetic media.

Data processing system 400 may be identical to, may be similar to, or may have components in common with or in communication with client 131, for example. In accordance with disclosed embodiments, instructions 424 may include instructions stored on a tangible computer readable medium for downloading one or more part specific mixes, up mixes, minus mixes, down mixes, rehearsal mixes, backing tracks, audio stems, click tracks, and the like. Further instructions are for accessing a plurality of music tracks of a composition, receiving user input requesting one or more rehearsal mixes, and providing the requested one or more rehearsal mixes for transport. One or more music tracks within a requested rehearsal mix are provided at adjusted (e.g., elevated, lowered, or muted) sound level(s) compared to other music tracks. The music tracks not requested at an adjusted level may be provided at a normal sound level intended for normal consumption. A user may specify that in a requested rehearsal mix a certain track or combination of tracks is at an elevated level, that another track or combination of tracks is at a lowered or muted level, and that yet another track or combination of tracks is at a normal level. In some cases, such as in an up mix, the music tracks not requested at an elevated level are provided at a reduced level that is lower than that intended for normal consumption.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the claimed subject matter is to be determined by the broadest permissible interpretation of the following claims and their equivalents, and shall not be restricted or limited by the foregoing detailed description.

What is claimed is:

1. A service for providing a rehearsal mix that includes a plurality of tracks, wherein a first portion of the plurality of tracks are provided substantially at or below a standard level, wherein a second portion of the plurality of tracks are provided at an elevated level that is higher than the standard level, wherein the second portion of the plurality of tracks and the first portion of the plurality of tracks if mixed at the standard level would result in a standard mix that is substantially identical to a master recording, the service comprising:
responsive to a user input, providing the rehearsal mix for transport through at least one of streaming or download.

2. The service according to claim 1, wherein said providing includes providing the rehearsal mix for download to a storage communicatively coupled to a user client.

3. The service according to claim 1, wherein said providing includes streaming the rehearsal mix for use substantially in real-time with at least one of a rehearsal or a performance.

4. The service according to claim 1, wherein said providing includes transporting a plurality of user datagram protocol (UDP) packets.

5. The service according to claim 1, wherein said providing includes transporting a plurality of transmission control protocol (TCP) packets.

6. The service according to claim 1, wherein the service further comprises:
providing for transport at least one backing track.

7. The service according to claim 6, wherein at least one transported backing track includes data from a plurality of musical instruments.

8. The service according to claim 1, wherein the rehearsal mix includes digital rights management data.

9. The service according to claim 8, wherein the rehearsal mix is limited in a number of times it can be played.

10. The service according to claim 8, wherein the rehearsal mix is limited in a number of times it can be copied.

11. The service according to claim 1, further comprising:
receiving further user input specifying the elevated level.

12. The service according to claim 11, further comprising:
storing the first portion of the plurality of tracks; and
responsive to the further user input, creating the second portion of the plurality of tracks.

13. The service according to claim 11, the service further comprising:
providing a click track for transport through at least one of streaming or download.

14. The service of claim 12, wherein one or more of the plurality of tracks are selectable according to a musical key.

15. A method of providing part specific mixes, the method comprising:
receiving a user input requesting a part specific mix, wherein the user input includes:
a composition identifier that indicates a musical composition;
a track identifier that indicates a track from the composition that is to be included in the part specific mix at an adjusted sound level that is higher or lower than sound levels of a plurality of other tracks within the composition; and
providing the part specific mix for transport through at least one of streaming or download.

16. The method of claim 15, wherein the user input further includes a backing track identifier that indicates a backing track from the composition, and wherein the method further comprises:
transporting the backing track through at least one of streaming or download.

17. The method of claim 16, wherein said transporting the backing track is to a user designee.

18. The method of claim 15, wherein the method further comprises:
providing a standard mix for transport, wherein the standard mix includes:
a copy of the musical composition that includes, at a standard sound level, a copy of the track from the composition that is to be included in the part specific mix at an adjusted sound level; and
copies of the plurality of other tracks within the composition at the standard sound level.

19. The method of claim 15, wherein said providing the part specific mix for transport to a user includes downloading the part specific mix to a storage communicatively coupled to a user client.

20. The method of claim 15, wherein said providing the part specific mix for transport to a user includes streaming the rehearsal mix for use substantially in real-time with a rehearsal.

21. The method of claim 15, further comprising:
including digital rights management data with the part specific mix.

22. The method of claim 21, wherein the part specific mix is limited in a number of times it can be played.

23. The method of claim 21, wherein the part specific mix is limited to playing during a predetermined period.

24. A computer program product stored on at least one tangible computer readable medium, wherein the computer program product is for providing rehearsal mixes, wherein the computer program product comprises instructions for:
accessing a plurality of music tracks of a composition, wherein individual music tracks from the plurality of music tracks include a standard sound level;
receiving user input requesting a rehearsal mix, wherein the requested rehearsal mix includes:
at least one of the plurality of music tracks at an adjusted sound level, wherein the adjusted sound level is one of greater or lower than the standard sound level; and
providing the requested rehearsal mix for transport through at least one of transport or download.

25. The computer program product of claim 24, further comprising instructions for:
providing one or more backing tracks for transport, wherein the one or more backing tracks correspond to a portion of the plurality of music tracks.
